(19) United States
(12) Patent Application Publication
(10) Pub. No.: US 2012/0009502 A1
(43) Pub. Date: Jan. 12, 2012

(54) FUEL CELL AND FLOW FIELD PLATE WITH FLOW GUIDE

(76) Inventors: Robert Mason Darling, South Windsor, CT (US); Eric J. O'Brien, Tolland, CT (US)

(21) Appl. No.: 13/258,036

(22) PCT Filed: Apr. 3, 2009
(86) PCT No.: PCT/US09/39410

§ 371 Date: Sep. 21, 2011

(51) Int. Cl. H01M 8/04

(52) U.S. Cl. 429/512

(57) ABSTRACT

A flow field plate for use in a fuel cell includes a non-porous plate body having a flow field. The flow field includes a plurality of channels and a flow distribution portion adjacent an end of the plurality of channels for distributing fluid between a manifold and the channels. A flow guide within the flow distribution portion establishes a desired flow distribution between the manifold and the plurality of channels.

### BACKGROUND OF THE DISCLOSURE

This disclosure relates to flow field plates in a fuel cell. Fuel cells typically include an anode catalyst, a cathode catalyst, and an electrolyte between the anode and cathode catalysts for generating an electric current in a known electrochemical reaction between reactants, such as fuel and oxidant. The fuel cell may include flow field plates with channels for directing the reactants to the respective catalyst. Conventional fuel cells utilize inlet and exit manifolds that extend through the flow field plates to deliver the reactant gases and coolant to the channels and receive exhaust gas and coolant from the channels. The flow field plates are typically rectangular.

The locations of the manifolds often necessitate a multi-pass flow field design in which a reactant flows from one side of the flow field to the other through a first set of channels and turns to flow back across the flow field in another set of channels to make at least several passes over the flow field. One challenge associated with a multi-pass design is achieving high fuel cell performance. For instance, the concentration, temperature, and other properties of the reactant gases change significantly through the channels and can diminish the performance of the fuel cell. Single pass designs with specific arrangements among the fuel, air, and coolant streams have been proposed as a solution to reduce changes in the concentration and temperature of the gases, for example. However, single pass designs do not provide adequate distribution of the reactant gases to the catalyst to achieve the desired performance with the given packaging and manifold location constraints.

### SUMMARY OF THE DISCLOSURE

An exemplary flow field plate for use in a fuel cell includes a non-porous plate body having a flow field. The flow field includes a plurality of channels and a flow distribution portion adjacent an end of the plurality of channels for distributing fluid between a manifold and the channels. A flow guide within the flow distribution portion establishes a desired flow distribution between the manifold and the plurality of channels.

An exemplary fuel cell includes an electrode assembly having an electrolyte between an anode catalyst and a cathode catalyst, and a plurality of manifolds for transporting fluids in the fuel cell. A non-porous plate body in the fuel cell includes a flow field adjacent the electrode assembly. The flow field includes a plurality of channels, a first flow distribution portion adjacent an inlet end of the channels, and a second flow distribution portion adjacent an outlet end of the channels for distributing the fluid between the manifolds and the channels. Flow guides within the first and second flow distribution portions establish a desired flow distribution between the manifolds and the channels.

An exemplary method of controlling fluid distribution in a fuel cell that includes the flow field plate includes establishing a desired flow distribution of a fluid between a manifold and the plurality of channels using the flow guide.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example fuel cell.

FIG. 2 illustrates an example flow field plate.

FIG. 3 illustrates a flow distribution portion of the flow field plate.

FIG. 4 illustrates another example flow distribution portion of a flow field plate.

### DETAILED DESCRIPTION OF THE PREFERRED EMBODIMENT

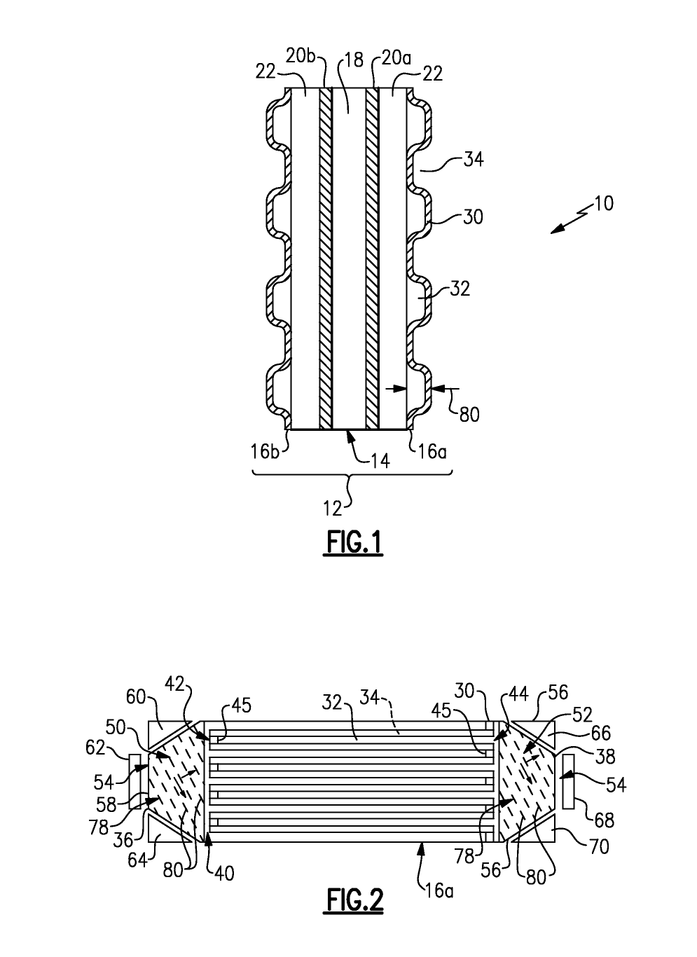

FIG. 1 illustrates a partially exploded view of selected portions of an example fuel cell 10 for generating an electric current in a known electrochemical reaction between reactant gases, for example. It is to be understood that the disclosed arrangement of the fuel cell 10 is only an example and that the concepts disclosed herein may be applied to other fuel cell arrangements.

The example fuel cell 10 includes one or more fuel cell units 12 that may be stacked in a known manner to provide the assembly of the fuel cell 10. Each of the fuel cell units 12 includes an electrode assembly 14 and flow field plates 16a and 16b for delivering reactant gases (e.g., air and hydrogen) to the electrode assembly 14. The flow field plate 16a may be regarded as an air plate for delivering air and the flow field plate 16b may be regarded as a fuel plate for delivering hydrogen. The flow field plate 16a, flow field plate 16b, or both may also circulate coolant (in coolant channels) for maintaining a desired operating temperature of the fuel cell 10 and hydrating the reactant gases indirectly by maintaining the electrode assembly 14 in a desired temperature range.

The electrode assembly 14 includes an electrolyte 18 between a cathode catalyst 20a and an anode catalyst 20b. Gas diffusion layers 22 may be used between the respective flow field plates 16a and 16b and the electrode assembly 14 to facilitate distribution of the reactant gases.

The flow field plates 16a and 16b may be substantially similar. Thus, the disclosed examples made with reference to the flow field plate 16a may also apply to the flow field plate 16b. In other examples, the flow field plate 16b may be different or include some of the same features as the flow field plate 16a.

The flow field plate 16a includes a non-porous plate body 30. Non-porous refers to the body being solid and free of pores that are known in porous plates for holding or transporting liquid water or other fluids. Thus, the non-porous plate body 30 is a barrier to fluids.

The non-porous plate body 30 includes reactant gas channels 32 and coolant channels 34. The reactant gas channels 32 are located on a side of the flow field plate 16a that faces in the direction of the electrode assembly 14 in the fuel cell unit 12 and the coolant channels 34 are located on the opposite side of the flow field plate 16a.

The flow field plate 16a may be stamped or otherwise formed into the desired shape. In this regard, positive features on one side of the flow field plate 16a are negative features on the other side, and vice versa. Stamping allows the flow field plate 16a to be made at a relatively low cost with a reduced need for machining operations, for example. The flow field plate 16a may be formed from steel, such as stainless steel, or other suitable alloy or material.

FIG. 2 illustrates one side of the flow field plate 16a. It is to be understood that the other side is the negative of the visible side. The channels 32 and 34 include inlets 42 for receiving a fluid (reactant gas or coolant) and outlets 44 for discharging the fluid. Optionally, the reactant gas channels 32 may include obstructions 45 in some of the channel inlets 42 and channel outlets 44. The obstructions 45 may completely block the given channel inlets 42 and channel outlets 44 such that the reactant gas channels 32 are interdigitated. Alternatively, the obstructions 45 may partially block the given channel inlets 42 and channel outlets 44 such that the reactant gas channels 32 are partially interdigitated.

The flow field plate 16a extends between a first terminal end 36 and a second terminal end 38 of the non-porous plate body 30 and includes flow fields 40 (one shown). The term “flow field” as used in this disclosure may refer to any or all of the channels 32 and 34 for delivering the air, fuel, and coolant and any other area between the channels 32 and 34 and manifolds for transporting the air, fuel, or coolant. The reactant gas channels 32 may be regarded as a flow field for the reactant gas (e.g., air in the case of flow field plate 16a and fuel in the case of flow field plate 16b) and the coolant channels 34 may be regarded as a flow field for coolant.

The flow fields 40 may each include a first flow distribution portion 50 and a second flow distribution portion 52. The flow fields of the reactant gases are active areas that are side by side with the electrode assembly 14, for delivering the reactant gases to the electrode assembly 14 for the electrochemical reaction. Thus, the first flow distribution portion 50 and the second flow distribution portion 52 are also side by side with a portion of the electrode assembly 14. In the illustrated example, the first flow distribution portion 50 diverges from the first terminal end 36 to the channel inlets 42, and the second first flow distribution portion 52 converges from the channel outlets 44 to the second terminal end 38.

The flow field plate 16a includes another first flow distribution portion 50 and another second flow distribution portion 52 (as the negative) on the back side of the flow field plate 16a for distributing the coolant to and from the coolant channels 34.

In the illustrated example, the flow field plate 16a has an irregular octagonal shape to achieve the divergent and convergent shape. However, the shape is not limited to octagonal, and in other examples the flow field plate 16a may have a different polygonal shape or a non-polygonal shape, such as elliptical, to achieve the divergent and convergent shape.

The first flow distribution portion 50 and the second flow distribution portion 52 may each include a straight end wall 54 and two straight side walls 56 that non-perpendicularly extend from the straight end wall 54. The angle between the side walls 56 and the end wall 54 provides the respective diverging or converging shape. The angles shown may be varied, depending on a desired degree of divergence or convergence.

The diverging and converging shapes of the respective first flow distribution portion 50 and second flow distribution portion 52 facilitate distribution of a fluid to the given flow field 40. For instance, the flow of a fluid delivered into the first flow distribution portion 50 follows along the side walls 56 to the outer channels near the edges of the flow field plate 16a. If the side walls 56 were perpendicular to the straight end wall 54, the fluid would not flow smoothly near the corner and flow into the outer channels would be inhibited. By sloping the side walls 56 relative to the end wall 54 to create a divergent shape, the first flow distribution portion 50 more uniformly distributes the fluid to the channels. Likewise, the second flow distribution portion 52 converges and thereby funnels the fluid flowing from the channels to facilitate collection of the fluid.

The fuel cell 10 also includes manifolds 60, 62, 64, 66, 68, and 70 to deliver and collect reactant gas and coolant to and from the flow fields 40. The manifolds 60 and 64 are located near the side walls 56 of the first flow distribution portion 50, and the manifold 62 is located near the end wall 54. The manifolds 66 and 70 are located near the side walls 56 of the second flow distribution portion 52, and the manifold 68 is located near the end wall 54.

The individual manifolds 60, 62, 64, 66, 68, and 70 may be used as inlets for delivering the fuel, air, or coolant to a given flow field 40 or as outlets for collecting the fuel, air, or coolant from the given flow field 40 to facilitate fluid distribution or achieve other fuel cell objectives.

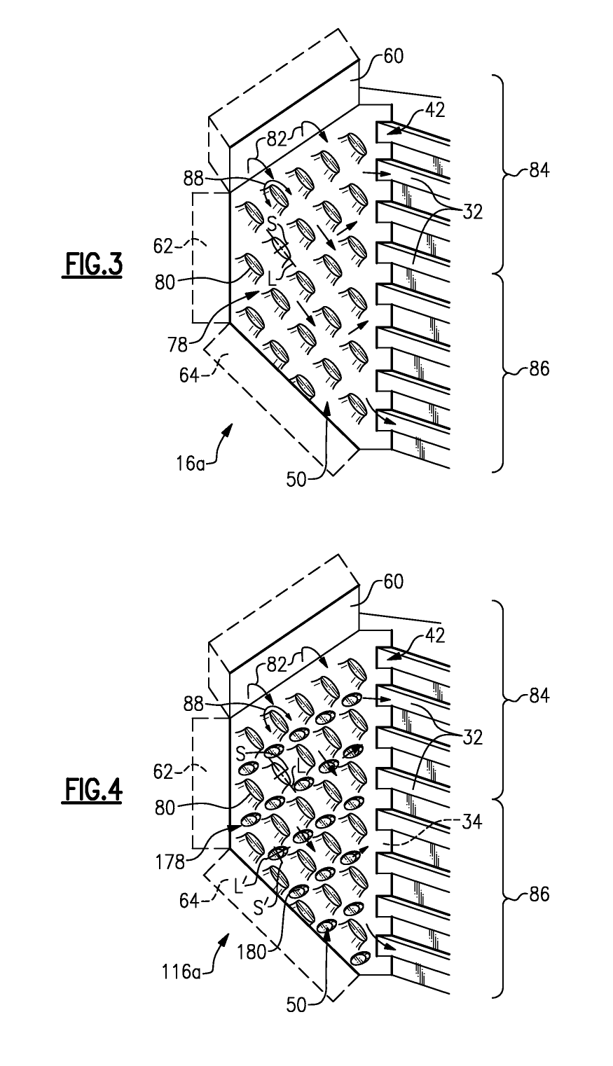

Referring also to FIG. 3, the first flow distribution portion 50, the second flow distribution portion 52, or both may include a flow guide 78 that establishes a desired flow distribution between a given manifold 60, 62, 64, 66, 68, and 70 and the channels. For example, the flow guide 78 may include protrusions 80 within the first flow distribution portion 50 and/or second flow distribution portion 52. The shape of the protrusions 80, arrangement of the protrusions 80, or both may contribute to establishing the desired flow distribution by limiting flow to or from selected reactant gas channels 32 and promoting flow to or from other of the reactant gas channels 32. Given this description, one of ordinary skill in the art will recognize particular shapes and arrangements to suit their particular needs.

The protrusions 80 may have a non-equiaxed cross-sectional shape, with long axes L and short axes S. In the given example, the long axes L of the protrusions 80 in the first flow distribution portion 50 are parallel and the long axes L of the protrusions 80 in the second flow distribution portion 52 are parallel, but are not necessarily parallel to the protrusions 80 in the first flow distribution portion 50. The protrusions 80 are generally arranged in rows, but other arrangements are contemplated. In this example, the protrusions 80 have an oval cross-section. In other examples, the protrusions 80 may have other non-equiaxed cross-sectional shapes.

The manifold 60 may deliver a reactant gas into the first flow distribution portion 50, as indicated by flow arrows 82. Although this example is made with reference to manifold 60, it is to be understood that the example may also apply to the other manifolds 62, 64, 66, 68, and 70. In this case, the manifold 60 is not equidistantly spaced from the inlets 42 of the reactant gas channels 32. Therefore, a portion 84 of the reactant gas channels 32 are located relatively close to the manifold 60 and another portion 86 are located relatively far from the manifold 60. The distances from the manifold 60 to the channels causes a tendency for non-uniform flow of the reactant gas into the reactant gas channels 32, which could diminish the performance of the fuel cell 10. However, the flow guide 78 counteracts the tendency by limiting flow to the closer channels 84 and promoting flow to the farther channels 86 to provide a more uniform flow into the reactant gas channels 32. A uniform flow into the reactant gas channels 32 provides the benefit of increased performance of the fuel cell 10.

The non-equiaxed cross-sectional shape of the protrusions 80 limits flow to the closer channels 84 and promotes flow to the farther channels 86. For instance, the reactant gas flows around the protrusions 80, as indicated by flow arrows 88. The protrusions 80 provide less obstruction to flow along the direction of the long axes L than along the direction of the short axes S because the protrusions 80 are relatively narrow along the short axes S and relatively wide along the long axes L.

Similar to the first flow distribution portion 50, the second flow distribution portion 52 may include a flow guide 78 for establishing a desired flow distribution between a given manifold 66, 68, and 70 and the channel outlets 44. For instance, the protrusions 80 may be oriented to limit flow between reactant gas channels 32 that are close to a given one of the manifolds 66, 68, or 70 and promote flow between reactant gas channels 32 that are far from a given one of the manifolds 66, 68, or 70.

FIG. 4 illustrates a portion of another example flow field plate 116a that may be used in the fuel cell 10 in place of the flow field plate 16a. In this disclosure, like reference numerals designate like elements where appropriate, and reference numerals with the addition of one-hundred or multiples thereof designate modified elements. The modified elements are understood to incorporate the same features and benefits of the corresponding original elements.

The protrusions 80 are positive features on the visible side of the flow field plate 116a but are negative features (depressions) on the back side that receives coolant. As negative features, the protrusions 80 may not have as much of an influence on the flow of the coolant. In this example, the first flow distribution portion 50 includes a flow guide 178 having the protrusions 80 and depressions 180. The depressions 180 are positive features on the coolant side of the flow field plate 116a (i.e., negative features on the visible reactant gas side).

The depressions 180 may also be non-equiaxed, with long axes L′ and short axes S′. In this case, the long axes L′ of the depressions 180 are transversely oriented relative to the long axes L of the protrusions 80, and the short axes S′ of the depressions 180 are transversely oriented relative to the short axes S of the protrusions 80. In one example, the long axes L′ are oriented 90° relative to the long axes L, and the short axes S′ are oriented 90°relative to the short axes S. The manifold 64 may deliver coolant and the depressions 180 (which may be regarded as protrusions relative to the coolant side) uniformly distribute the coolant to the coolant channels 34. In some examples, the depressions 180 may be smaller or differently shaped than the protrusions 80 because the distribution needs of the coolant may differ from the distribution needs of the reactant gas.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A flow field plate for use in a fuel cell, comprising:
a non-porous plate body including a flow field having a plurality of channels and a flow distribution portion adjacent one end of the plurality of channels for distributing fluid between a manifold and the plurality of channels; and
a flow guide within the flow distribution portion that establishes a desired flow distribution between the manifold and the plurality of channels.

2. The flow field plate as recited in claim 1, wherein the flow guide includes a plurality of protrusions within the flow distribution portion.

3. The flow field plate as recited in claim 1, wherein the flow guide includes a plurality of non-equiaxed protrusions within the flow distribution portion.

4. The flow field plate as recited in claim 1, the flow guide includes a plurality of protrusions within the flow distribution portion and each of the protrusions includes a long axis and a short axis oriented perpendicularly relative to the long axis, and the long axes are substantially parallel.

5. The flow field plate as recited in claim 1, wherein the flow guide includes a plurality of protrusions within the flow distribution portion and each of the protrusions includes a long axis and a short axis oriented perpendicularly relative to the long axis, and the long axis is oriented in a direction toward a portion of the plurality of channels that are distally located from the manifold.

6. The flow field plate as recited in claim 1, wherein the flow guide includes protrusions and depressions, and the protrusions are transversely oriented relative to the depressions.

7. The flow field plate as recited in claim 1, wherein the flow guide includes a plurality of protrusions within the flow distribution portion, and each of the plurality of protrusions has an elliptical cross-sectional shape.

8. The flow field plate as recited in claim 1, wherein the flow guide includes a plurality of depressions within the flow distribution portion.

9. The flow field plate as recited in claim 1, wherein the plurality of channels include channel inlets and channel outlets, with obstructions in a portion of the channel inlets and channel outlets that completely block the given channel inlets and channel outlets such that the plurality of channels are interdigitated.

10. The flow field plate as recited in claim 1, wherein the plurality of channels include channel inlets and channel outlets, with obstructions in a portion of the channel inlets and channel outlets that partially block the given channel inlets and channel outlets such that the plurality of channels are partially interdigitated.

11. A fuel cell comprising:
an electrode assembly including an electrolyte between an anode catalyst and a cathode catalyst;
a plurality of manifolds for transporting fluids in the fuel cell;
a non-porous plate body including a flow field having a plurality of channels, a first flow distribution portion at an inlet end of the plurality of channels, and a second flow distribution portion at an outlet end of the plurality of channels for distributing the fluid between the plurality of manifolds and the plurality of channels, and flow guides within the first and second flow distribution portions that establish a desired flow distribution between the plurality of manifolds and the plurality of channels.

12. The fuel cell as recited in claim 11, wherein the flow guides are non-equiaxed.

13. The fuel cell as recited in claim 12, wherein each of the flow guides includes a long axis and a short axis oriented perpendicularly relative to the long axis, and the long axes of the flow guides in the first flow distribution portion are parallel and the long axes of the flow guides in the second flow distribution portion are parallel.

14. The fuel cell as recited in claim 12, wherein a portion of the flow guides on a reactant gas side of the non-porous plate body are angled relative to another portion of the flow guides on a coolant side of the non-porous plate body.

15. A method of controlling fluid distribution in a fuel cell comprising a non-porous plate body having a flow field including a plurality of channels and a flow distribution portion between adjacent an end of the plurality of channels, and a flow guide within the flow distribution portion, the method comprising:
establishing a desired flow distribution of a fluid between the manifold and the plurality of channels using the flow guide.

16. The method as recited in claim 15, including limiting flow between the manifold and a portion of the channels.

17. The method as recited in claim 15, including promoting more flow between the manifold and a portion of the channels.

18. The method as recited in claim 15, including limiting flow between the manifold and a portion of the channels that are proximately located to the manifold and promoting more flow between the manifold and another portion of the channels that are distally located from the manifold.
